(19) United States
(12) Patent Application Publication
(10) Pub. No.: US 2015/0280430 A1
(43) Pub. Date: Oct. 1, 2015

(54) LEAKAGE DETECTION PROTECTION CIRCUIT WITH FUNCTION OF REGULAR SELF-EXAMINATION OF SEPARATE ELEMENTS

(71) Applicant: Wenzhou Van-Sheen Electric Appliance Co. Ltd., Yuqing (CN)

(72) Inventor: Huadao Huang, Yueqing (CN)

(73) Assignee: Wenzhou Van-Sheen Electric Appliance Co. Ltd.

(21) Appl. No.: 14/657,814

(22) Filed: Mar. 13, 2015

(30) Foreign Application Priority Data
Mar. 25, 2014 (CN) 201410112580.3

(51) Int. Cl. H02H 9/08

(52) U.S. Cl. CPC H02H 9/08

(57) ABSTRACT

A leakage detection protection circuit with function of regular self-examination of separate elements comprises a power input port, a power user port, a power output port, a reset button, main loop switches, dual induction coils, a tripping coil, a silicon controlled rectifier, a control chip, and a regular self-examination circuit. The regular self-examination circuit includes a self-examination chip and a second silicon controlled rectifier. A trigger electrode of the silicon controlled rectifier is connected to a drive pin of the control chip and to an A/D conversion interface of the self-examination chip. An anode of the silicon controlled rectifier is connected to another A/D conversion interface of the self-examination chip. The self-examination chip has a processing module, which acquires electrical parameters of the drive pin of the control chip and electrical parameters of the anode of the silicon controlled rectifier and compares said electrical parameters with respective pre-determined parameters to determine whether the control chip and the silicon controlled rectifier are in a normal operating state.

### CROSS-REFERENCE TO RELATED APPLICATION

This application claims priority to and incorporates herein Chinese patent application numbers 201410112580.3, filed on Mar. 25, 2014.

### TECHNICAL FIELD

The present invention relates to the field of power sockets, in particular to a leakage detection protection circuit with function of regular self-examination of separate elements.

### BACKGROUND

A leakage detection protection circuit disclosed in the Chinese patent application No. 20131045956.0 comprises: a power input port; a power user port; a power output port; a reset button; main loop switches linked with the reset button; dual induction coils for detecting current leakage and low-resistance failure; a tripping coil, which drives a built-in iron core, by means of magnetic field effect, to work with a mechanical structure, so as to allow the reset button to bring the main loop switches closed/open; a silicon controlled rectifier for providing a passageway for the tripping coil; a control chip, which controls the silicon controlled rectifier on and off through detection results from the dual induction coils; and a regular self-examination circuit. The circuit determines and inspects whether the protection circuit is in good condition through testing whether the main loop switches can successfully be tripped and turned off. The circuit needs complex determining process in order to determine whether each of the separate elements (mainly including the tripping coil, the silicon controlled rectifier, and the control chip IC1) is in good condition, the structure of the circuit therefore needs improvement.

### SUMMARY

The object of the present invention is to overcome the shortcomings of the prior art, and to provide a leakage detection protection circuit with function of regular self-examination of separate elements.

Consistent with the present disclosure, the following technical solution is provided herein. A leakage detection protection circuit with function of regular self-examination of separate elements, comprising: a power input port; a power user port; a power output port; a reset button; main loop switches KR2-1, KR2-2 linked with the reset button; dual induction coils T1, T2 for detecting current leakage and low-resistance failure; a tripping coil L1, which drives a built-in iron core, by means of magnetic field effect, to work with a mechanical structure, so as to allow the reset button to bring the main loop switches closed/open; a silicon controlled rectifier SCR1 for providing a passageway for the tripping coil; and a control chip IC1, which controls the silicon controlled rectifier on and off through detection results from the dual induction coils; and a regular self-examination circuit. The regular self-examination circuit includes a self-examination chip IC2 and a second silicon controlled rectifier SCR2. A trigger electrode of the silicon controlled rectifier SCR1 is connected to a drive pin of the control chip IC1 and to an A/D conversion interface of the self-examination chip IC2. An anode of the silicon controlled rectifier SCR1 is connected to another A/D conversion interface of the self-examination chip IC2. The self-examination chip IC2 has a processing module, which acquires electrical parameters of the drive pin of the control chip IC1 and electrical parameters of the anode of the silicon controlled rectifier SCR1 and compares said electrical parameters with respective pre-determined parameters to determine whether the control chip IC1 and the silicon controlled rectifier SCR1 are in a normal operating state.

Further, the anode of said second silicon controlled rectifier SCR2 is connected to a live line passing through the dual induction coils or a live line of the power input port via a 16th resistor R16, the cathode of the second silicon controlled rectifier SCR2 is grounded, the trigger electrode of the second silicon controlled rectifier SCR2 is connected to the drive pin of the self-examination chip IC2, one power terminal of the self-examination chip IC2 is connected to a null line of the power input port or a null line passing through the dual induction coils, another power terminal of the self-examination chip IC2 is grounded, the second silicon controlled rectifier SCR2, together with the power input port, forms a loop passing through the dual induction coils.

Further, the trigger electrode of the second silicon controlled rectifier SCR2 is connected to the A/D interface of the self-examination chip IC2 via a 24th resistor R24, the anode of the silicon controlled rectifier SCR1 is connected to another A/D interface of the self-examination chip 1C2 via a 22th resistor R22.

Further, the self-examination chip IC2 has an output interface for outputting a turn-on signal of driving the silicon controlled rectifier SCR1, the output interface is connected to an input interface of the trigger electrode of the silicon controlled rectifier SCR1.

Preferably, there are also provided a pair of normally-open switches (K3B-1, K3B-2), which are closed upon a successful resetting so as to conductively connect the power user port and the power output port. The normally-open switches (K3B-1, K3B-2) are linked with the reset button. The normally-open switches (K3B-1, K3B-2) include a pair of movable contact-levers and a pair of static contact terminals. The pair of movable contact-levers are respectively routed to the corresponding terminals of the power output port. The pair of static contact terminals are respectively routed to the corresponding terminals of the power user port.

As a second preferred embodiment, there are also provided a pair of normally-open switches (K3B-1, KR3B-2), which are closed upon a successful resetting so as to conductively connect the power output port and the power input port, the normally-open switches (K3B-1, KR3B-2) are linked with the reset button, the normally-open switches (K3B-1, KR3B-2) include a pair of movable contact-levers and a pair of static contact terminals, the pair of movable contact-levers are respectively routed to the corresponding terminals of the power input port, the pair of static contact terminals are respectively routed to the corresponding terminals of the power output port.

As a third preferred embodiment, there are also provided a pair of normally-open switches (K3B-1, K3B-2), which are closed upon a successful resetting so as to conductively connect the power user port and the power output port. The normally-open switches (K3B-1, K3B-2) are linked with the reset button. The normally-open switches comprise a pair of movable contact pieces, which are connected to the power terminals. The pair of movable contact pieces are below or above the main loop switches, when the main loop switches are closed; the movable contact pieces of the normally-open switches (K3B-1, K3B-2); and the movable contact-levers of the main loop switches and the static contact terminals of the main loop switches are in contact with one another and are conductively connected.

As a fourth preferred embodiment, there are also provided a pair of normally-open switches (K3B-1, K3B-2) including a pair of a movable contact-levers and a pair of static contact terminals. The pair of static contact terminals are respectively routed to the corresponding terminals of the power output port. The pair of movable contact-levers of the normally-open switches (K3B-1, K3B-2) are respectively routed to the live line and the null line passing through the dual induction coils.

Further, the leakage detection protection circuit further comprises a simulated-current-leakage generating resistor R4. The simulated current generating resistor R4 forms a simulated-current-leakage loop passing through the dual induction coils T1, T2 via the reset button.

Further, it further comprises a test button. One terminal of the test button is connected to one terminal of the power input port via the simulated-current-leakage generating resistor R4, and the other terminal is connected to the other phase of the static contact terminals of the main loop switches.

Further, it further comprises a piezoresistor provided between the two phases of said power input port; at least one terminal of the power input port has a discharge metal sheet, which extends towards another terminal of the power input port to form a discharge gap.

The beneficial effect, consistent with the present disclosure, is as follows: it respectively acquires electrical parameters of the silicon controlled rectifier, the control chip, and the entire detection protection circuit; it is able to rapidly determine which of the separate elements is damaged at end of the life of the leakage detection protection circuit; it is safe and easy to use; the presence of the normally-open switches prevents accidents occurring at the power user port upon reverse connection; the power input port is provided with the piezoresistor and the discharge metal sheet to effectively prevent damage of the circuit by instantaneous high voltage.

### BRIEF DESCRIPTION OF THE DRAWINGS

FIG. 1 is a circuit diagram of the first embodiment of the present invention;

FIG. 2 is a circuit diagram of the second embodiment of the present invention;

FIG. 3 is a circuit diagram of the third embodiment of the present invention;

FIG. 4 is a circuit diagram of the fourth embodiment of the present invention.

### DETAILED DESCRIPTION

The present invention is further described in detail with references to drawings and embodiments.

### Embodiment 1

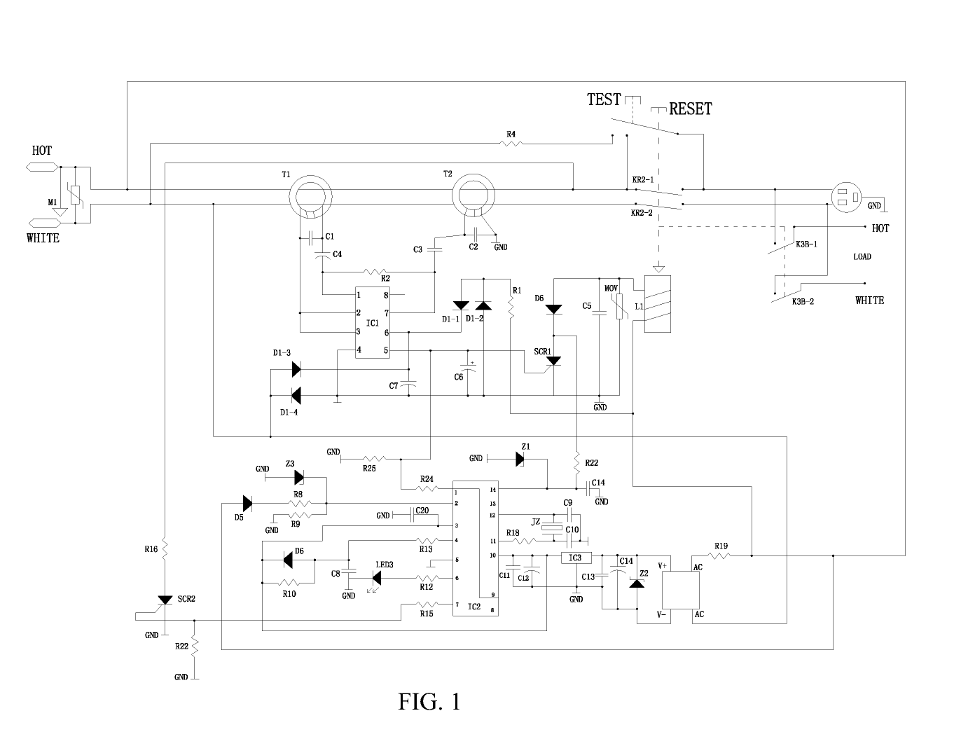

Referring to FIG. 1, a leakage detection protection circuit with function of regular self-examination of separate elements according to the embodiment comprises: a power input port; a power user port; a power output port; a reset button; main loop switches (KR2-1, KR2-2) linked with the reset button; dual induction coils (T1, T2) for detecting current leakage and low-resistance failure; a tripping coil L1, which drives a built-in iron core, by means of magnetic field effect, to work with a mechanical structure, so as to allow the reset button to bring the main loop switches closed/open; a silicon controlled rectifier SCR1 for providing a passageway for the tripping coil; a control chip IC1, which controls the silicon controlled rectifier on and off through detection results from the dual induction coils; and a regular self-examination circuit, including a self-examination chip IC2 and a second silicon controlled rectifier SCR2. A trigger electrode of the silicon controlled rectifier SCR1 is connected to a drive pin of the control chip IC1 and to an A/D conversion interface of the self-examination chip IC2. The anode of the silicon controlled rectifier SCR1 is connected to another A/D conversion interface of the self-examination chip IC2. The self-examination chip IC2 has a processing module, which acquires electrical parameters of the drive pin of the control chip IC1 and electrical parameters of the anode of the silicon controlled rectifier SCR1, and compares said electrical parameters with respective pre-determined parameters to determine whether the control chip IC1 and the silicon controlled rectifier SCR1 are in a normal operating state.

To simplify the circuit, the anode of the second silicon controlled rectifier SCR2 is connected to a live line passing through the dual induction coils or a live line of the power input port (in the current embodiment, it is connected to the live line of the power input port that passes through the dual induction coils at a point before the movable contact-lever of the main loop switch KR2-1) via a sixteenth resistors R16. The cathode of the second silicon controlled rectifier SCR2 is grounded. The trigger electrode of the second silicon controlled rectifier SCR2 is connected to the drive pin of the self-examination chip IC2. One power terminal of the self-examination chip IC2 is connected to a null line of the power input port or a null line passing through the dual induction coils (in the current embodiment, it is connected to the null line not passing through the dual induction coils). Another power terminal of the self-examination chip is grounded. The second silicon controlled rectifier S CR2, together with the power input port, forms a loop passing through the dual induction coils. The power terminals of the self-examination chip IC2 are connected to a filtering network (the 11th capacitor and the 12th capacitor), a voltage regulator circuit (IC3) and a bridge rectifier circuit (the box labeled V+, V−). One AC input terminal of the bridge rectifier circuit is connected to the live line of the power input port via a 19th resistor, and another AC input terminal of the bridge rectifier circuit is connected to the null line of the power input port.

The electrical parameters acquired in the embodiment are voltage signals, the trigger electrode of the second silicon controlled rectifier SCR1 is connected to the A/D interface (pin 1) of the self-examination chip IC2 via a 24^{th} resistor R24. The anode of the silicon controlled rectifier SCR1 is connected to another A/D interface (pin 14) of the self-examination chip IC2 via a 22^{th} resistor R22.

For the convenience of detecting whether a triggering signal for the silicon controlled rectifier SCR1 output from the control chip IC1 is normal and for the purpose of outputting a triggering signal for the silicon controlled rectifier SCR1 by the self-examination chip IC2 itself through the same interface, the self-examination chip IC2 is further provided with an output interface (pin 9) for outputting a turn-on signal for driving the silicon controlled rectifier SCR1. The output interface is connected to the input interface (pin 1) of the trigger electrode of the silicon controlled rectifier SCR1, which significantly simplifies the circuit.

In the embodiment, for reverse connection protection, there are also provided a pair of normally-open switches (K3B-1, K3B-2), which are closed upon a successful resetting, so as to conductively connect the power user port and the power output port. The normally-open switches (K3B-1, K3B-2) are linked with the reset button. The normally-open switches (K3B-1, K3B-2) include a pair of movable contact-levers and a pair of static contact terminals. The pair of movable contact-levers are respectively routed to the corresponding terminals of the power output port, and the pair of static contact terminals are respectively routed to the corresponding terminals of the power user port.

For convenience of generating simulated-current-leakage, the embodiment further comprises a simulated-current-leakage generating resistor R4, which forms a simulated-current-leakage loop passing through the dual induction coils (T1, T2) via the reset button.

For convenience of manually testing whether the circuit has come to the end of its life when the main loop switches are closed, there is also provided a test button TEST. One terminal of the test button is connected to the power input port via the simulated-current-leakage generating resistor R4, and the other terminal thereof is connected to the other phase of the static contact terminals of the main loop switches. The test button can further be connected to a resistor for shorting out the power input port. The embodiment simplifies the circuit by means of the simulated-current-leakage generation resistor.

In order to prevent damage of the circuit due to transient high voltage such as lighting, a piezoresistor is provided between two phases of the power input port; at least one terminal of the power input port has a discharge metal piece M1, which extends toward the other terminal of the power input port and forms a discharge gap.

### Embodiment 2

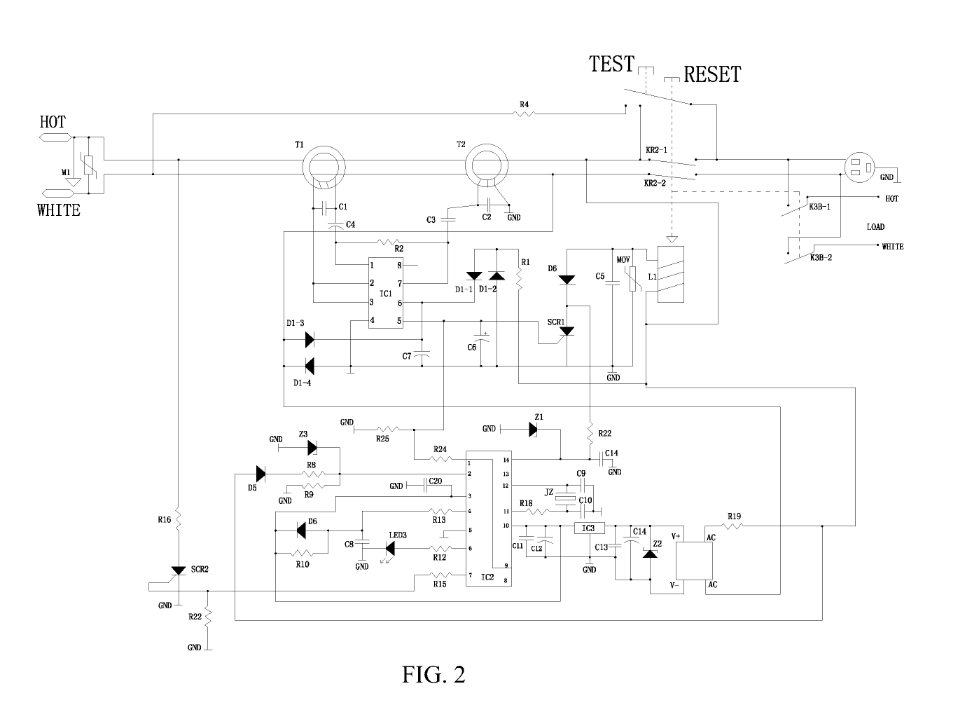

Referring to FIG. 2, in the embodiment, the anode of the second silicon controlled rectifier SCR2 is connected to the live line of the power input port not passing through the dual induction coils. The power terminal of the self-examination chip IC2 is connected to the null line passing through the dual induction coils, thereby forming a loop passing through the dual induction coils. The structure of the normally-open switches is identical to that of in the embodiment 1.

### Embodiment 3

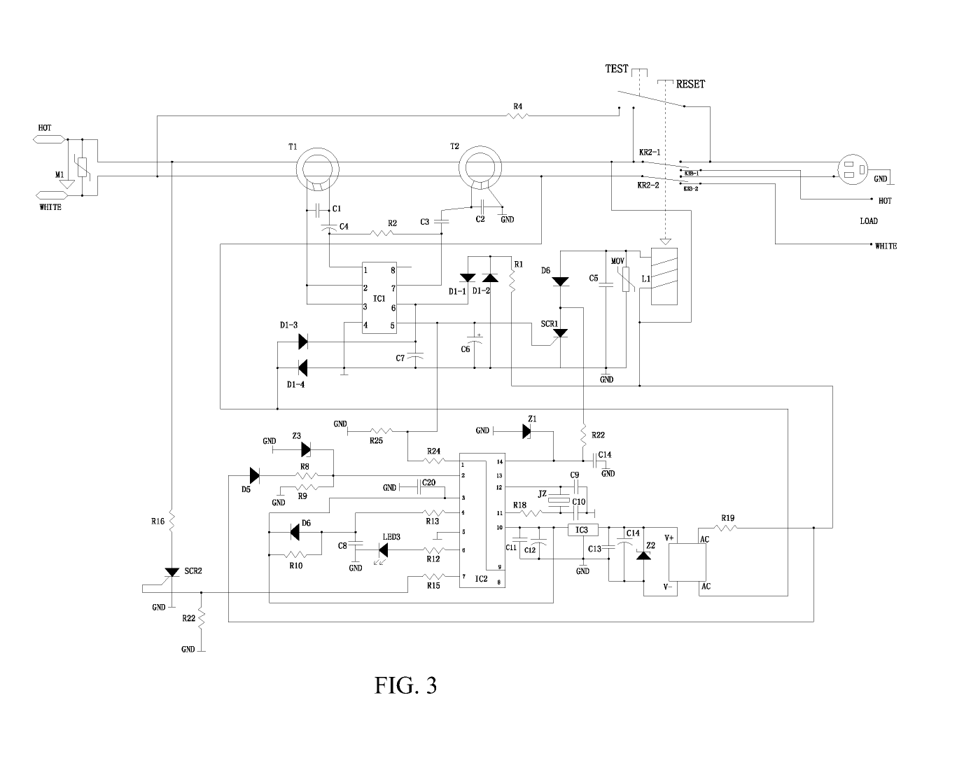

Referring to FIG. 3, the connection of the second silicon controlled rectifier SCR2 is identical to that of the embodiment 2. But the connection of the normally-open switches for the reverse connection protection is different from that of the embodiment 1. The normally-open switches (K3B-1, K3B-2) in this embodiment comprise a pair of movable contact pieces, which are connected to the power output port. The pair of movable contact pieces are located below (or above) the movable contact-levers of the main loop switches. When the main loop switches are closed, the movable contact pieces of the normally-open switches (K3B-1, K3B-2); the movable contact-levers of the main loop switches; and the static contact terminals of the main loop switches are in contact with one another and are conductively connected.

### Embodiment 4

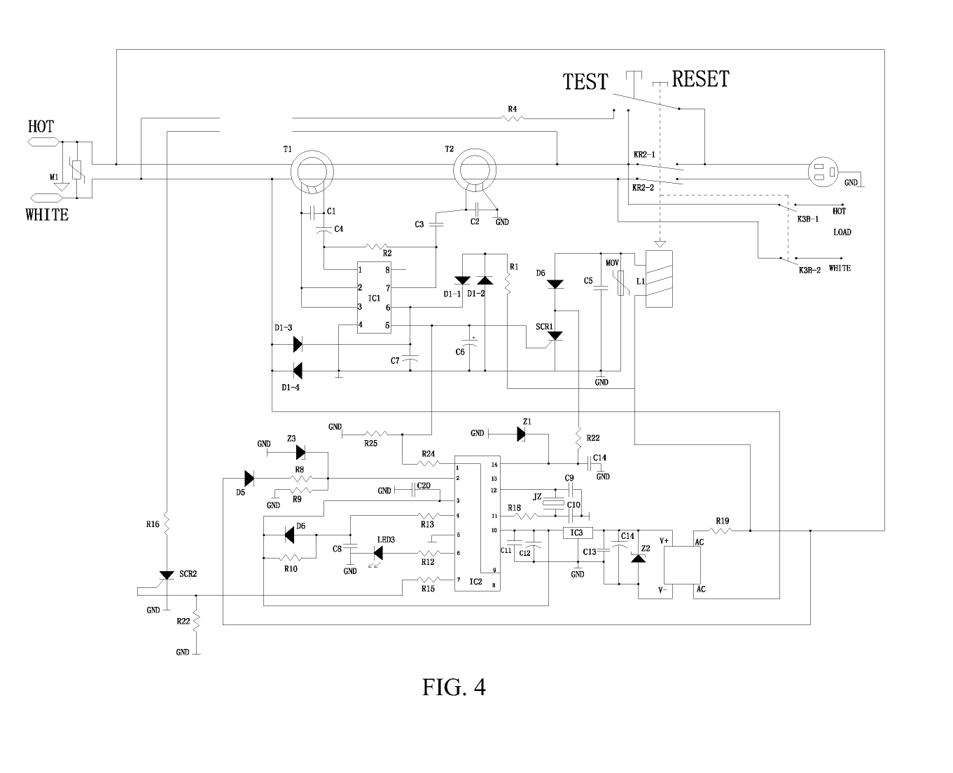

Referring to FIG. 4, the normally-open switches (K3B-1, K3B-2) in this embodiment include a pair of a movable contact-levers and a pair of static contact terminals. The pair of static contact terminals are respectively routed to the corresponding terminals of the power output port. The pair of movable contact-levers of the normally-open switches (K3B-1, K3B-2) are respectively routed to the live line and the null line passing through the dual induction coils. The connection of the second silicon controlled rectifier SCR2 in this embodiment is identical to that of the embodiment 1.

While the invention has been described and illustrated with references to preferred embodiments, one of ordinary skill in the art should understand that the invention is not limited to the embodiments described above, the form and detail can be varied within the scope of the claims.

What is claimed is:

1. A leakage detection protection circuit with function of regular self-examination of separate elements, comprising:
a power input port;
a power user port;
a power output port;
a reset button; main loop switches linked with the reset button;
dual induction coils for detecting current leakage and low-resistance failure;
a tripping coil, which drives a built-in iron core, by means of magnetic field effect, to work with a mechanical structure, so as to allow the reset button to bring the main loop switches closed/open;
a first silicon controlled rectifier for providing a passageway for the tripping coil; and
a control chip which controls the first silicon controlled rectifier on and off through detection results from the dual induction coils; and
a regular self-examination circuit,
wherein the regular self-examination circuit includes a self-examination chip and a second silicon controlled rectifier; a trigger electrode of the first silicon controlled rectifier is connected to a drive pin of the control chip and to an A/D conversion interface of the self-examination chip; an anode of the first silicon controlled rectifier is connected to another A/D conversion interface of the self-examination chip; the self-examination chip has a processing module, which acquires electrical parameters of the drive pin of the control chip and electrical parameters of the anode of the first silicon controlled rectifier and compares said electrical parameters with respective pre-determined parameters to determine whether the control chip and the first silicon controlled rectifier are in a normal operating state.

2. The leakage detection protection circuit with function of regular self-examination of separate elements according to claim 1, wherein the anode of said second silicon controlled rectifier is connected, via a resistor, to a live line passing through the dual induction coils or a live line of the power input port; the cathode of the second silicon controlled rectifier is grounded; the trigger electrode of the second silicon controlled rectifier is connected to the drive pin of the self-examination chip; one power terminal of the self-examination chip is connected to a null line of the power input port or a null line passing through the dual induction coils; another power terminal of the self-examination chip is grounded; and the second silicon controlled rectifier, together with the power input port, forms a loop passing through the dual induction coils.

3. The leakage detection protection circuit with function of regular self-examination of separate elements according to claim 1, wherein the trigger electrode of the second silicon controlled rectifier is connected to the A/D interface of the self-examination chip via a first resistor; and the anode of the first silicon controlled rectifier is connected to another A/D interface of the self-examination chip via a second resistor.

4. The leakage detection protection circuit with function of regular self-examination of separate elements according to claim 3, wherein the self-examination chip has an output interface for outputting a turn-on signal of driving the first silicon controlled rectifier, the output interface is connected to an input interface of the trigger electrode of the first silicon controlled rectifier.

5. The leakage detection protection circuit with function of regular self-examination of separate elements according to claim 1, further comprising
a pair of normally-open switches, which are closed upon a successful resetting so as to conductively connect the power user port and the power output port,
wherein the normally-open switches are linked with the reset button; the normally-open switches include a pair of movable contact-levers and a pair of static contact terminals; the pair of movable contact-levers are respectively routed to the corresponding terminals of the power output port; and the pair of static contact terminals are respectively routed to the corresponding terminals of the power user port.

6. The leakage detection protection circuit with function of regular self-examination of separate elements according to claim 1, further comprising
a pair of normally-open switches, which are closed upon a successful resetting so as to conductively connect the power output port and the power input port,
wherein the normally-open switches are linked with the reset button; the normally-open switches include a pair of movable contact-levers and a pair of static contact terminals; the pair of movable contact-levers are respectively routed to the corresponding terminals of the power input port; and the pair of static contact terminals are respectively routed to the corresponding terminals of the power output port.

7. The leakage detection protection circuit with function of regular self-examination of separate elements according to claim 1, further comprising a pair of normally-open switches, which are closed upon a successful resetting so as to conductively connect the power user port and the power output port,
wherein the normally-open switches are linked with the reset button; the normally-open switches comprise a pair of movable contact pieces, which are connected to the power terminals; the pair of movable contact pieces are below or above the main loop switches; and when the main loop switches are closed, the movable contact pieces of the normally-open switches, and the movable contact-levers of the main loop switches and the static contact terminals of the main loop switches are in contact with one another and are conductively connected.

8. The leakage detection protection circuit with function of regular self-examination of separate elements according to claim 1, further comprising a pair of normally-open switches, which are closed upon a successful resetting so as to conductively connect the power user port and the power output port,
wherein the normally-open switches in this embodiment include a pair of a movable contact-levers and a pair of static contact terminals; the pair of static contact terminals are respectively routed to the corresponding terminals of the power output port; and the pair of movable contact-levers of the normally-open switches are respectively routed to the live line and the null line passing through the dual induction coils.

9. The leakage detection protection circuit with function of regular self-examination of separate elements according to claim 1, further comprising a simulated-current-leakage generating resistor, the simulated current generating resistor forming a simulated-current-leakage loop passing through the dual induction coils via the reset button.

10. The leakage detection protection circuit with function of regular self-examination of separate elements according to claim 6, further comprising a test button, wherein one terminal of the test button is connected to one terminal of the power input port via a simulated-current-leakage generating resistor, the other terminal is connected to the other phase of the static contact terminals of the main loop switches.

11. The leakage detection protection circuit with function of regular self-examination of separate elements according to claim 7, further comprising a piezoresistor provided between the two phases of said power input port, wherein at least one terminal of the power input port has a discharge metal sheet, which extends towards another terminal of the power input port to form a discharge gap.
